(19) United States
(12) Patent Application Publication
(10) Pub. No.: US 2006/0199011 A1
(43) Pub. Date: Sep. 7, 2006

(54) Use of aqueous microcapsule dispersions as heat transfer liquids

(75) Inventor: Ekkehard Jahns, Weinheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, Ludwigshafen (DE)

(21) Appl. No.: 10/552,073

(22) PCT Filed: Apr. 14, 2004
(86) PCT No.: PCT/EP04/03959

§ 371 Date: Oct. 4, 2005

(30) Foreign Application Priority Data
Apr. 17, 2003 (DE) 103 18 044.3

(51) Int. Cl. B32B 15/02

(52) U.S. Cl. 428/402.24

(57) ABSTRACT

Use of aqueous microcapsule dispersions with latent heat storage materials as capsule core and a polymer as shell, which are obtainable by heating an oil-in-water emulsion in which the monomers, free radical initiators and the latent heat storage materials are present as a disperse phase, where the monomer mixture comprises
30 to 100% by weight, based on the total weight of the monomers, of one or more monomers I chosen from C₁-C₂₄-alkyl esters of acrylic acid and methacrylic acid, methacrylic acid and methacrylonitrile, 0 to 80% by weight, based on the total weight of the monomers, of a bi- or polyfunctional monomer II which is insoluble or sparingly soluble in water and 0 to 40% by weight, based on the total weight of the monomers, of other monomers III, as heat transfer liquids.

The present invention relates to the use of aqueous microcapsule dispersions with latent heat storage materials as capsule core as heat transfer liquids, and to the heat exchanger systems comprising them.

An important research goal is to reduce the requirement for energy and to utilize existing heat energy. Here, a particular concern is the improvement of energy-intensive systems, such as heating and cooling systems, which often have unsatisfactory efficiency. One approach to solving this problem is to increase the heat storage capacity of the liquid heat transfer medium through the addition of latent heat storage materials. Thus, a greater amount of energy can be transported using less pump energy and/or smaller pipe cross sections and smaller heat exchangers. A further advantage is the increased heat storage possibility in the overall system of pipelines and heat exchangers, such that it is often possible to dispense with further storage possibilities, such as additional containers or tanks.

The mode of function of latent heat storage materials is based on the conversion enthalpy which arises during the solid/liquid phase transition, which signifies an absorption of energy or release of energy into the surrounding area.

For heating and cooling systems in which heat is absorbed or released by a heat transfer liquid, a distinction is made in principle between dynamic systems and static systems. In the dynamic systems, heat energy is transferred from a heat source initially to the heat transfer liquid by means of a heat-absorbing device. This energy is then transported to a device for releasing heat, where the heat is absorbed by a heat receiver, for example the surrounding area. The heat transfer liquid is then transported back to the heat-absorbing device. In the static systems, the heat is released to a heat reservoir, which then releases the absorbed heat to a heat receiver at a later time. Heat transfer liquids in static systems are often also referred to as heat storage liquids.

In such heat transfer liquids with latent heat storage media, these are generally in disperse form, i.e. the latent heat storage media are suspended in the liquid. In this connection, it must be taken into consideration that on the one hand, it would be desirable to have the largest possible amount of latent heat storage material in suspended form in order to achieve increased heat capacity. On the other hand, an increased concentration of latent heat storage materials reduces the pumpability of the suspension because the viscosity of the suspension increases greatly with increased content of latent heat storage material. Not infrequently, such suspensions are also unstable, resulting in separations.

U.S. Pat. No. 5,007,478 describes cooling elements in which microcapsule suspensions with latent heat storage materials are surrounded by a container. The capsule materials proposed are polyvinyl alcohol and polystyrene.

U.S. Pat. No. 4,911,232 teaches heat transfer liquids for heat exchangers which are suspensions of a liquid and microencapsulated latent heat storage materials. Polymers are generally specified as wall material for the microcapsules.

U.S. Pat. No. 6,284,158 describes the use of latent heat storage materials which are absorbed in porous polymers such as acrylate copolymers and are then used in heat transfer liquids. A disadvantage is that the porous structure releases the latent heat storage materials again.

DE-A-1 96 54 035 teaches microcapsule dispersions with latent heat storage materials as capsule core as fluid heat transfer media. The heat transfer liquid comprises microcapsules with a wall made of melamine resin particles. A possible wall material which is mentioned is, inter alia, also polymethyl methacrylate. However, melamine resin particles have the disadvantage of not being adequately hydrolysis-stable indefinitely.

It is therefore an object of the present invention to provide heat transfer liquids which do not have the disadvantages of the prior art.

We have found that this object is achieved by the use of aqueous microcapsule dispersions with latent heat storage materials as capsule core and a polymer as shell, which are obtainable by heating an oil-in-water emulsion in which the monomers, free radical initiators and the latent heat storage materials are present as a disperse phase, where the monomer mixture comprises
30 to 100% by weight, based on the total weight of the monomers, of one or more monomers I chosen from C₁-C₂₄-alkyl esters of acrylic acid and methacrylic acid, methacrylic acid and methacrylonitrile,
0 to 80% by weight, based on the total weight of the monomers, of one or more bi- or polyfunctional monomers II which is insoluble or sparingly soluble in water and
0 to 40% by weight, based on the total weight of the monomers, of other monomers III,
   as heat transfer liquids.

The microcapsules present in the dispersions used according to the invention are particles with a capsule core which consists predominantly, usually to an extent of more than 95% by weight, of latent heat storage materials, and a polymer as capsule wall. Depending on the temperature, the capsule core is solid or liquid. The average particle size of the capsules (number-average by means of light scattering) is 0.5 to 100 μm, preferably 1 to 50 μm, particularly preferably 1 to 6 μm. If the microcapsule dispersions are used as heat transfer liquids in dynamic systems, an average particle size of the capsules of from 1 to 10 μm, in particular 1 to 6 μm, is preferred. The weight ratio of capsule core to capsule wall is generally from 50:50 to 95:5. Preference is given to a core/wall ratio of from 70:30 to 90:10.

According to the definition, latent heat storage materials are substances which have a phase transition in the temperature range in which a heat transfer should be undertaken. Preferably, the latent heat storage media have a solid/liquid phase transition in the range from −20° C. to 120° C. The latent heat storage media are generally organic, preferably lipophilic, substances.

Examples of Suitable Substances are:
aliphatic hydrocarbon compounds, such as saturated or unsaturated C₁₀-C₄₀-hydrocarbons, which are branched or preferably linear, e.g. such as n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, and cyclic hydrocarbons, e.g. cyclohexane, cyclooctane; cyclodecane;
aromatic hydrocarbon compounds, such as benzene, naphthalene, biphenyl, o- or n-terphenyl, C₁-C₄₀-alkyl-substituted aromatic hydrocarbons such as dodecylbenzene, tetradecylbenzene, hexadecylbenzene, hexylnaphthalene or decylnaphthalene;
saturated or unsaturated C₆-C₃₀-fatty acids, such as lauric acid, stearic acid, oleic acid or behenic acid, preferably eutectic mixtures of decanoic acid with, for example, myristic acid, palmitic acid or lauric acid;
fatty alcohols, such as lauryl alcohol, stearyl alcohol, oleyl alcohol, myristyl alcohol, cetyl alcohol, mixtures such as coconut fatty alcohol, and the oxo alcohols obtained by hydroformylating α-olefins and other reactions;
C₆-C₃₀-fatty amines, such as decylamine, dodecylamine, tetradecylamine or hexadecylamine;
esters, such as C₁-C₁₀-alkyl esters of fatty acids, such as propyl palmitate, methyl stearate or methyl palmitate, and, preferably, their eutectic mixtures, or methyl cinnamate;
natural and synthetic waxes, such as montanic acid waxes, montanic ester waxes, carnauba wax, polyethylene wax, oxidized waxes, polyvinyl ether wax, ethylene-vinyl acetate wax or hard waxes from the Fischer-Tropsch process;
halogenated hydrocarbons, such as chloroparaffin, bromooctadecane, bromopentadecane, bromononadecane, bromoeicosane, bromodocosane.

Mixtures of these substances are also suitable provided the freezing point is not lowered such that it is outside of the desired range, or the melting heat of the mixture becomes too low for a useful application.

For example, the use of pure n-alkanes, n-alkanes with a purity greater than 80% or of alkane mixtures, as are produced as an industrial distillate and are commercially available as such, is advantageous.

In addition, the abovementioned halogenated hydrocarbons can be admixed as flameproofing agents. It is also possible to add flameproofing agents such as decabromodiphenyl oxide, octabromodiphenyl oxide, antimony oxide or flameproofing additives described in U.S. Pat. No. 4,797,160. They are added in amounts of from 1 to 30% by weight, based on the capsule core.

It is also advantageous to add to the latent heat storage materials compounds which are soluble therein in order, in so doing, to prevent the lowering of the freezing point which sometimes arises in the case of the nonpolar substances. As is described in U.S. Pat. No. 5,456,852, it is advantageous to use compounds with a melting point which is higher by 20 to 120° C. than that of the actual core substance. Suitable compounds are the fatty acids, fatty alcohols, fatty amides, and aliphatic hydrocarbon compounds, such as n-alkanes, mentioned above as lipophilic substances. They are added in amounts of from 0.1 to 10% by weight, based on the capsule core.

The lipophilic substances are chosen according to the temperature range within which heat storage is desired. For example, for cooling purposes, preference is given to using lipophilic substances whose solid/liquid phase transition is in the temperature range from −20 to 20° C. Thus, individual substances or mixtures with conversion temperatures of from 4° C. to 20° C. are usually chosen for use in air conditioning units. For the transportation or the storage of low-temperature heat for heating purposes, use is made of individual substances or mixtures with conversion temperatures of from 15° C. to 60° C. and, for heating installations for the transportation or the storage of heat, individual substances or mixtures with conversion temperatures of from 50° C. to 120° C. The term low-temperature heat and heating installations also cover solar applications, which have very similar storage and transport issues.

In the microcapsules according to the invention, the shell-forming polymers are made up from 30 to 100% by weight, preferably 30 to 95% by weight, in particular 50 to 90% by weight, of one or more C₁-C₂₄-alkyl esters of acrylic acid and methacrylic acid, methacrylic acid and methacrylonitrile as monomers I. In addition, the polymers may comprise, in copolymerized form, up to 80% by weight, preferably 5 to 60% by weight, in particular 10 to 50% by weight, of one or more bi- or polyfunctional monomers II, which are insoluble or sparingly soluble in water. In addition, the polymers can comprise, in copolymerized form, up to 40% by weight, preferably up to 30% by weight, of other monomers III.

Preference is given to microcapsules whose capsule wall is a highly crosslinked methacrylic ester polymer. The degree of crosslinking here is achieved using a crosslinker proportion (monomer II) of ≧10% by weight, based on the overall polymer.

Suitable monomers I are, in particular, C₁-C₁₂-alkyl esters of acrylic and/or methacrylic acid. Particularly preferred monomers I are methyl acrylate, ethyl acrylate, n-propyl acrylate and n-butyl acrylate and/or the corresponding methacrylates. Preference is given to isopropyl acrylate, isobutyl acrylate, sec-butyl acrylate and tert-butyl acrylate and the corresponding methacrylates. Mention may also be made of methacrylonitrile and methacrylic acid. In general, the methacrylates are preferred.

Suitable monomers II are bi- or polyfunctional monomers which are insoluble or sparingly soluble in water, but have good to limited solubility in the lipophilic substance. Sparingly soluble is understood as meaning a solubility of less than 60 g/l at 20° C.

Bi- or polyfunctional monomers are understood as meaning compounds which have at least two nonconjugated ethylenic double bonds. In particular, divinyl and polyvinyl monomers are suitable; these bring about crosslinking of the capsule wall during the polymerization.

Preferred bifunctional monomers are the diesters of diols with acrylic acid or methacrylic acid, and also the diallyl and divinyl ethers of these diols.

Preferred divinyl monomers are ethanediol diacrylate, divinylbenzene, ethylene glycol dimethacrylate, 1,3-butylene glycol dimethacrylate, methallylmethacrylamide and allyl methacrylate. Particular preference is given to propanediol diacrylate, butanediol diacrylate, pentanediol diacrylate and hexanediol diacrylate or the corresponding methacrylates.

Preferred polyvinyl monomers are trimethylolpropane triacrylate and methacrylate, pentaerythritol triallyl ether and pentaerythritol tetraacrylate.

Suitable other monomers III are monoethylenically unsaturated monomers different from the monomers I, preference being given to monomers IIIa such as styrene, α-methylstyrene, α-methylstyrene, vinyl acetate, vinyl propionate and vinylpyridine.

Particular preference is given to the water-soluble monomers IIIb, e.g. acrylonitrile, acrylamide, methacrylamide, acrylic acid, itaconic acid, maleic acid, maleic anhydride, N-vinylpyrrolidone, 2-hydroxyethyl acrylate and methacrylate and acrylamido-2-methylpropanesulfonic acid. In addition, particular mention should be made of N-methylolacrylamide, N-methylolmethacrylamide, dimethylaminoethyl methacrylate and diethylaminoethyl methacrylate.

The microcapsules suitable for the use according to the invention can be prepared by in situ polymerization.

The preferred microcapsules and their preparation are known from EP-A-457 154, to which reference is expressly made. For example, the microcapsules are prepared by using the monomers, a free radical initiator, a protective colloid and the lipophilic substance to be encapsulated to produce a stable oil-in-water emulsion, in which they are in the form of a disperse phase. The proportion of the oil phase in the oil-in-water emulsion is preferably 20 to 60% by weight.

The polymerization of the monomers is then triggered by heating, during which the polymers which arise form the capsule wall which surrounds the lipophilic substance.

The polymerization is generally carried out at 20 to 100° C., preferably at 40 to 80° C. The dispersion and polymerization temperature should naturally be above the melting temperature of the lipophilic substances so that, if appropriate, free radical initiators are chosen whose decomposition temperature is above the melting point of the lipophilic substance.

The reaction times for the polymerization are normally 1 to 10 hours, in most cases 2 to 5 hours.

In terms of process engineering the general procedure is to disperse, simultaneously or in succession, a mixture of water,.monomers, protective colloids, the lipophilic substances, free radical initiators and, if appropriate, regulators, and to heat this dispersion with thorough stirring to the decomposition temperature of the free radical initiators. The rate of the polymerization can be controlled here through the choice of temperature and the amount of the free radical initiator. The reaction is expediently started by increasing the temperature to an initial temperature, and the polymerization is controlled by further increasing the temperature.

After the final temperature has been reached, the polymerization is expediently continued for a period of up to 2 hours in order to reduce the content of residual monomers.

Following the actual polymerization reaction, at a conversion of 90 to 99% by weight, it is generally advantageous to substantially free the aqueous microcapsule dispersions from odor carriers, such as residual monomers and other organic volatile constituents. This can be achieved in a manner known per se, physically, by distillative removal (in particular by means of steam distillation) or by stripping with an inert gas. In addition, it may be carried out chemically, as described in WO 9924525, advantageously by redox-initiated polymerization, as described in DE-A-4435 423, DE-A4419518 and DE-A-4435422.

This method gives microcapsules of the desired average particle size in the range from 0.5 to 100 μm, it being possible to adjust the particle size in a manner known per se via the shear force, the stirring speed, the protective colloid and its concentration.

Preferred protective colloids are water-soluble polymers since these lower the surface tension of water from a maximum of 73 mN/m to 45 to 70 mN/m and thus ensure the formation of closed capsule walls.

The microcapsules are prepared in the presence of at least one organic protective colloid, which may either be anionic or neutral. It is also possible to use anionic and nonionic protective colloids together.

Organic neutral protective colloids are cellulose derivatives, such as hydroxyethylcellulose, carboxymethylcellulose and methylcellulose, polyvinylpyrrolidone, copolymers of vinylpyrrolidone, gelatin, gum arabic, xanthan, sodium, alginate, casein, polyethylene glycols, preferably polyvinyl alcohol, and partially hydrolyzed polyvinyl acetates.

To improve the stability of the emulsions it is possible to add anionic protective colloids. The co-use of anionic protective colloids is particularly important when the microcapsule content in the dispersion is high since without additional ionic stabilizer, agglomerated microcapsules may form. These agglomerates reduce the yield of useful microcapsules if the agglomerates are of small capsules with a diameter of from 1 to 3 μm, and increase the sensitivity to fracture if the agglomerates are greater than about 10 μm.

Suitable anionic protective colloids are polymethacrylic acid, the copolymers of sulfoethyl acrylate and methacrylate, of sulfopropyl acrylate and methacrylate, of N-(sulfoethyl)maleimide, of 2-acrylamido-2-alkylsulfonic acids, of styrenesulfonic acid, and of vinylsulfonic acid.

Preferred anionic protective colloids are naphthalenesulfonic acid and naphthalenesulfonic acid-formaldehyde condensates, and especially polyacrylic acids and phenolsulfonic acid-formaldehyde condensates.

The anionic protective colloids are generally used in amounts of from 0.1 to 10% by weight, based on the water phase of the emulsion.

Preference is given to inorganic solid particles, so-called Pickering systems. They act like protective colloids. They permit stabilization of the oil-in-water emulsion by very fine solid particles. The particles remain solid under the reaction conditions. They are insoluble in water, but are dispersible or are neither soluble nor dispersible in water but are wettable by the lipophilic substance.

Microencapsulations using such Pickering systems are described, for example, in U.S. Pat. No. 3,615,972, U.S. Pat. No. 4,016,110, WO 99 24525 and the earlier German application 101 63 162.6.

A Pickering system can consist of the solid particles on their own or additionally of auxiliaries which improve the dispersibility of the particles in water or the wettability of the particles by the lipophilic phase. These auxiliaries are, for example, nonionic, anionic, cationic or zwitterionic surfactants or polymeric protective colloids, as are described above or below. It is additionally possible to add buffer substances in order to adjust the water phase to a certain advantageous pH. This may reduce the solubility of the fine particles in water and increase the stability of the emulsion. Customary buffer substances are phosphate buffer, acetate buffer and citrate buffer.

The inorganic solid particles may be metal salts, such as salts, oxides and hydroxides of calcium, magnesium, iron, zinc, nickel, titanium, aluminum, silicon, barium and manganese. Compounds to be mentioned are magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may also be mentioned. Particular preference is given to highly disperse silicas, magnesium pyrophosphate and tricalcium phosphate.

Preference is given to inorganic solid particles with an average size of from 5 to 1000 nm, preferably 5 to 500 nm, in particular 7 to 200 nm. The sizes given refer to the number-average of the colloid dispersion used, determined by means of light scattering.

The Pickering systems can either be added firstly to the water phase, or to the stirred emulsion of oil-in-water. Some fine, solid particles are prepared by precipitation. For example, the magnesium pyrophosphate is prepared by combining the aqueous solutions of sodium pyrophosphate and magnesium sulfate.

As a rule, the pyrophosphate is prepared immediately prior to dispersion by combining an aqueous solution of an alkali metal pyrophosphate with at least the stoichiometrically required amount of a magnesium salt, where the magnesium salt may be in solid form or in the form of an aqueous solution. In a preferred embodiment, the magnesium pyrophosphate is prepared by combining aqueous solutions of sodium pyrophosphate (Na₄P₂O₇) and magnesium sulfate (MgSO₄×7H₂O).

The highly disperse silicas can be dispersed as fine, solid particles in water. It is, however, also possible to use so-called colloidal dispersions of silica in water. The colloidal dispersions are alkaline, aqueous mixtures of silica. In the alkaline pH range the particles are swollen and are stable in water. For a use of these dispersions as a Pickering system it is advantageous for the pH during the oil-in-water emulsion to be adjusted with an acid to a pH of from 2 to 7.

The inorganic protective colloids are generally used in amounts of from 0.5 to 15% by weight, based on the water phase.

In general, the organic neutral protective colloids are used in amounts of from 0.1 to 15% by weight, preferably from 0.5 to 10% by weight, based on the water phase.

The dispersing conditions for preparing the stable oil-in-water emulsion are chosen in a manner known per se such that the oil droplets have the size of the desired microcapsules.

The aqueous microcapsule dispersions obtained can be used directly as heat transfer liquid. For the purposes of-this application, the term heat transfer liquid means liquids for the transportation of heat and also liquids for the transportation of cold, i.e. cooling liquids. The principle of the transfer of heat energy is the same in both cases and differs merely in the direction of transfer.

Such heat transfer liquids are used according to the invention in a system comprising a heat-absorbing section and a section which gives off the heat, between which the heat transfer liquid is circulated, and if appropriate a pump to transport the heat transfer liquid. In this connection, the heat transfer liquid is passed close by to the heat source in order to achieve the quickest possible heat absorption and thus heat transfer. The cycle proceeds to the heat-releasing section, where this time the heat release takes place to the cooler heat receiver. In such a heat exchange circuit, the heat transfer liquid may move solely by convection. At least one pump is preferably used, in order also to ensure rapid energy dissipation or more rapid heat exchange between the heat source and the consumer. Control options for maximum heat transport and heat transfer are the speed of the heat transfer liquid, the choice and thus the thermal capacity and the amount of the particular latent heat storage materials and the lowest possible viscosity of the heat transfer liquid while it is in motion. When choosing the latent heat storage materials it is to be ensured that the temperature of the heat source is above the melting point of the heat transfer liquid and the temperature of the heat receiver is below its solidification point. Melting point and solidification point are not necessarily the same here since, as already mentioned above, reductions in the freezing point may also result.

The types and modes of function of such dynamic systems have been known to the person skilled in the art for a long time, e.g. from Ullmanns Encyclopedia of Industrial Chemistry, 5th ed on CD-Rom, “Heat Exchange”. They are used, for example, in heating and cooling systems for buildings, heating and cooling systems for automobiles, in solar installations, in cooling and freezing devices, as industrial heat exchangers, as personal comfort systems, and for microclimate heating and cooling systems.

The heat transfer liquids according to the invention can also be used in a static system. Such systems are described, for example, in U.S. Pat. No. 5,007,478, the statements of which should be encompassed by this application. Cooling by means of a static system is used, for example, for electronic components and in computers in order to dissipate their heat. The heat transfer liquid here is enclosed in a container. The energy exchange also takes place here via a heat exchanger, which is connected to the container or via a heat exchanger within the container and simply via the container surface itself. Here, they absorb short-term energy peaks or ensure temperature equalization over relatively long periods.

The microcapsule dispersions exhibit excellent mechanical properties. They are also stable under the pump conditions. In addition, they have good hydrolysis stability.

The examples below are intended to illustrate the invention in more detail. Unless stated otherwise, the percentages given are percentages by weight.

### EXAMPLE 1

Water phase

| | | |
|---|---|---|
| 572 | g | of water |
| 80 | g | of a 50% strength colloidal dispersion of SiO₂ in water at |
| | | pH 9.3 (average particle size 108.6 nm, number-average |
| | | according to light-scattering) |
| 2.1 | g | of a 2.5% strength aqueous sodium nitrite solution |
| 20 | g | of a 1% strength aqueous methylcellulose solution (viscosity |
| | | 15 000 mPas at 2% in water) |

Oil phase

| | | |
|---|---|---|
| 440 | g | of n-tetradecane |
| 9 | g | of paraffin wax 68-72° C. |
| 77 | g | of methyl methacrylate |
| 33 | g | of butanediol diacrylate |
| 0.76 | g | of ethylhexyl thioglycolate |
| 1.35 | g | of t-butyl perpivalate |

Feed 1: 1.09 g of t-butyl hydroperoxide, 70% strength in water

Feed 2: 0.34 g of ascorbic acid, 0.024 g of NaOH, 56 g of H₂O

At room temperature, the above water phase was initially introduced and adjusted to pH 4 using 3 g of 10% strength nitric acid. Following the addition of the oil phase, the mixture was dispersed using a high-speed dissolver stirrer at 4800 rpm. Dispersion for 40 minutes gave a stable emulsion with a particle size of 1 to 9 μm in diameter. With stirring using an anchor stirrer, the emulsion was heated to 56° C. within 40 minutes, to 58° C. within a further 20 minutes, to 71 ° C. within a further 60 minutes and to 85° C. within a further 60 minutes. The microcapsule dispersion obtained was cooled to 70° C. with stirring and feed 1 was added thereto. Feed 2 was metered in over 80 minutes with stirring at 70° C. The mixture was then cooled. The microcapsule dispersion obtained had a solids content of 47.2% and an average particle size of 5.8 μm (volume-average value, measured by means of Fraunhofer diffraction).

Upon dilution with water to a solids content of about 30%, the dispersion had a viscosity of less than 10 mPas and could be pumped in a heat cycle with 2 double-pipe heat exchangers.

### EXAMPLE 2

Water phase

| | | |
|---|---|---|
| 333 | g | of water |
| 188 | g | of a 10% strength aqueous solution of polyvinyl alcohol (88% |
| | | hydrolyzed, average molecular weight 128 000) |

Oil phase

| | | |
|---|---|---|
| 440 | g | of paraffin 62-64° C. |
| 56.1 | g | of methyl methacrylate |
| 18.7 | g | of butanediol diacrylate |
| 0.76 | g | of ethylhexyl thioglycolate |
| 0.92 | g | of t-butyl perpivalate |

Feed 1: 1.09 g of t-butyl hydroperoxide, 70% strength in water

Feed 2: 0.34 g of ascorbic acid, 56 g of H₂O

At room temperature, the above water phase was initially introduced. Following the addition of the oil phase, the mixture was dispersed with a high-speed dissolver stirrer at 4000 rpm and 70° C. Dispersion for 20 minutes gave a stable emulsion with a particle size of 1 to 8 μm in diameter. With stirring using an anchor stirrer, the emulsion was kept at 70° C. for 1 hour and then heated to 85° C. over the course of 6.0 minutes. Feed 1 was added to the resulting microcapsule dispersion with stirring at 85° C. Feed 2 was metered in over 80 minutes with stirring. From the start of the addition of feed 1, the mixture was cooled to room temperature over 90 minutes. The resulting microcapsule dispersion had a solids content of 49.5% and an average particle size of 4.9 μm (volume-average value, measured by means of Fraunhofer diffraction).

Upon dilution with water to a solids content of about 30%, the dispersion had a viscosity of less than 10 mPas and could be pumped in a heat cycle with 2 double-pipe heat exchangers.

1-8. (canceled)

9. A process for the use of aqueous microcapsule dispersions with latent heat storage materials as capsule core and a polymer as shell, which are obtained by heating an oil-in-water emulsion in which the monomers, free radical initiators and the latent heat storage materials are present as a disperse phase, wherein the monomer mixture comprises:
30 to 95% by weight, based on the total weight of the monomers, of one or more monomers I selected from the group consisting of C₁-C₂₄ alkyl esters of acrylic acid and methacrylic acid, methacrylic acid and methacrylonitrile;
5 to 80% by weight, based on the total weight of the monomers, of a bi- or polyfunctional monomer II, which is insoluble or sparingly soluble in water; and
0 to 40% by weight, based on the total weight of the monomers, of other monomers III,
as heat transfer liquids.

10. The process for the use of aqueous microcapsule dispersions according to claim 9, wherein the average particle size of the microcapsules is 0.5 to 100 μm.

11. The process for the use of aqueous microcapsule dispersions according to claim 9, wherein the latent heat storage materials are lipophilic substances which have their solid/liquid phase transition in the temperature range from −20 to 120° C.

12. The process for the use of aqueous microcapsule dispersions according to claim 9, wherein the polymer is a highly crosslinked methacrylic ester polymer.

13. The process for the use of aqueous microcapsule dispersions according to claim 9, wherein the oil-in-water emulsion comprises inorganic solid particles with an average size of from 0.005 to 1 μm.

14. The process for the use of aqueous microcapsule dispersions according to claim 9 as heat transfer liquid in a system comprising a heat-absorbing section and a section which gives off the heat, between which the heat transfer liquid is circulated, and if appropriate a pump to transport the heat transfer liquid.

15. The process for the use of aqueous microcapsule dispersions according to claim 9 as heat transfer liquid in a static system.

16. The process for the use of aqueous microcapsule dispersions according to claim 9 as heat transfer liquid, in systems selected from the group consisting of heating and cooling system for buildings, heating and cooling system for automobiles, solar installations, chilling and freezing devices, industrial heat exchangers, cooling for computers and electronics, personal comfort systems, and microclimate heating and cooling systems.
